(19) United States
(12) Patent Application Publication
(10) Pub. No.: US 2023/0247151 A1
(43) Pub. Date: Aug. 3, 2023

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM CORPORATION, Tokyo (JP)

(72) Inventor: Yuichi SHIHO, Kanagawa (JP)

(21) Appl. No.: 18/049,298

(22) Filed: Oct. 25, 2022

(30) Foreign Application Priority Data
Feb. 2, 2022 (JP) 2022-015015

(51) Int. Cl. H04N 1/00

(52) U.S. Cl. CPC H04N 1/00514; H04N 1/0097; H04N 1/00925; H04N 1/00482; H04N 1/00832; H04N 1/00517

(57) ABSTRACT

An information processing apparatus includes a processor configured to, in a case where a process is executed, generate setting information in which a setting value in executing the process is stored for each setting item, display a setting screen including personal setting information usable by only a specific user and shared setting information usable by plural users, in a case where the personal setting information is changed to the shared setting information, and a designation of a setting item for which a change of the setting value is prohibited among setting items included in the setting information is received, assign an attribute for prohibiting the change of the setting value to the setting item for which the designation for prohibiting the change of the setting value is received, and in a case where the process is executed using the setting information including the setting item to which the attribute for prohibiting the change of the setting value is assigned, assign the attribute for prohibiting the change of the setting value to a setting item corresponding to the setting item to which the attribute for prohibiting the change of the setting value is assigned among setting items of setting information generated in a case where the process is executed.

### CROSS-REFERENCE TO RELATED APPLICATIONS

This application is based on and claims priority under 35 USC 119 from Japanese Patent Application No. 2022-015015, filed on Feb. 2, 2022, the entire disclosure of which is incorporated by reference herein.

### BACKGROUND

### (i) Technical Field

The present invention relates to an information processing apparatus, a non-transitory computer readable medium storing a program, and an information processing method.

### (ii) Related Art

JP2020-154819A discloses an information processing apparatus that acquires identification information for identifying a user, receives an execution request of a job with respect to an apparatus of a target to be used, executes the job using a function of the apparatus, generates the identification information and an execution result of the job as history information, conceals all or a part of the history information in accordance with authorization of a viewer, and presents the concealed history information.

JP5032361B discloses an automatic job template generation apparatus that collects an operation history of a multifunction apparatus for each user based on information accessed by the multifunction apparatus on the Web, analyzes an operation frequency at a constant timing based on the collected operation history, and newly creates a job execution parameter of which the operation frequency is high on an operation screen as a job template button based on the analysis result.

### SUMMARY

A function of storing a setting value for each setting item of a process executed in the past as setting information and using the stored setting information so that a process having the same setting content as the process executed in the past can be executed has been used. In such a function, in a case where the setting information frequently used by a plurality of users is registered as shared setting information, the plurality of users can use the same setting information.

In a case where the shared setting information is provided to the plurality of users, execution of the process in a state where a setting value of a specific setting item is changed may be to be prohibited. However, even in a case where an attribute for prohibiting the change of the setting value is assigned to the specific setting item included in the shared setting information, the process can be executed in a state where the setting value of the specific setting item is changed, in a case where the process is executed using the shared setting information or in a case where the shared setting information is duplicated as personal setting information.

Aspects of non-limiting embodiments of the present disclosure relate to an information processing apparatus, a non-transitory computer readable medium storing a program, and an information processing method that, in a case where an attribute for prohibiting a change of a setting value is assigned to a specific setting item of shared setting information usable by a plurality of users, can prevent execution of a process in a state where the setting value of the setting item is changed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to, in a case where a process is executed, generate setting information in which a setting value in executing the process is stored for each setting item,

display a setting screen including personal setting information usable by only a specific user and shared setting information usable by a plurality of users,

in a case where the personal setting information is changed to the shared setting information, and a designation of a setting item for which a change of the setting value is prohibited among setting items included in the setting information is received, assign an attribute for prohibiting the change of the setting value to the setting item for which the designation for prohibiting the change of the setting value is received, and

in a case where the process is executed using the setting information including the setting item to which the attribute for prohibiting the change of the setting value is assigned, assign the attribute for prohibiting the change of the setting value to a setting item corresponding to the setting item to which the attribute for prohibiting the change of the setting value is assigned among setting items of setting information generated in a case where the process is executed.

### BRIEF DESCRIPTION OF THE DRAWINGS

Exemplary embodiment(s) of the present invention will be described in detail based on the following figures, wherein:

FIG. 1 is a diagram illustrating a system configuration of an image forming system of an exemplary embodiment of the present invention;

FIG. 2 is a block diagram illustrating a hardware configuration of an image forming apparatus 10 in the exemplary embodiment of the present invention;

FIG. 3 is a block diagram illustrating a functional configuration of the image forming apparatus 10 in the exemplary embodiment of the present invention;

FIG. 4 is a diagram illustrating an example of a personal setting information management table stored in a setting information storage unit 37;

FIG. 5 is a diagram illustrating an example of a shared setting information management table stored in the setting information storage unit 37;

FIG. 6 is a diagram illustrating a display screen example displayed in a case where a user performs a touch operation on an icon for using a quick function;

FIG. 7 is a diagram for describing an operation example in a case where a general user registers job history information as personal setting information by pinning the job history information;

FIG. 8 is a diagram illustrating an operation screen example after job history information 64 is pinned to be changed to personal setting information 65;

FIG. 9 is a diagram illustrating an operation menu example in a case where a user A operates an operation menu button 60 of personal setting information 66 in a pinned state;

FIG. 10 is a diagram illustrating an operation example in a case where a manager user registers new shared setting information;

FIG. 11 is a diagram illustrating an operation screen example after job history information 67 is changed to shared setting information 68;

FIG. 12 is a flowchart illustrating an operation in a case where an operation in assigning an attribute for prohibiting a change of a setting value to a part of setting items is performed in changing the personal setting information to the shared setting information;

FIG. 13 is a diagram illustrating an example of the shared setting information to which the attribute for prohibiting the change of the setting value is assigned with respect to the part of the setting items;

FIG. 14 is a diagram illustrating an operation screen example in a case where the general user attempts to execute a printing job using the shared setting information illustrated in FIG. 13;

FIG. 15 is a flowchart illustrating an operation of the image forming apparatus 10 in a case where a job is executed using the shared setting information including a setting item to which an attribute “unchangeable” is assigned;

FIG. 16 is a diagram illustrating an example of the job history information generated in a state where an additional attribute for making an executed setting content unchangeable is also included;

FIG. 17 is a diagram for describing an operation in a case where the general user changes the shared setting information to personal setting information of the general user; and

FIG. 18 is a diagram illustrating a state of newly creating and adding personal setting information 72 having the same setting content as shared setting information 69 on a list display screen in a state where the shared setting information 69 is left.

### DETAILED DESCRIPTION

Next, an exemplary embodiment of the present invention will be described in detail with reference to the drawings.

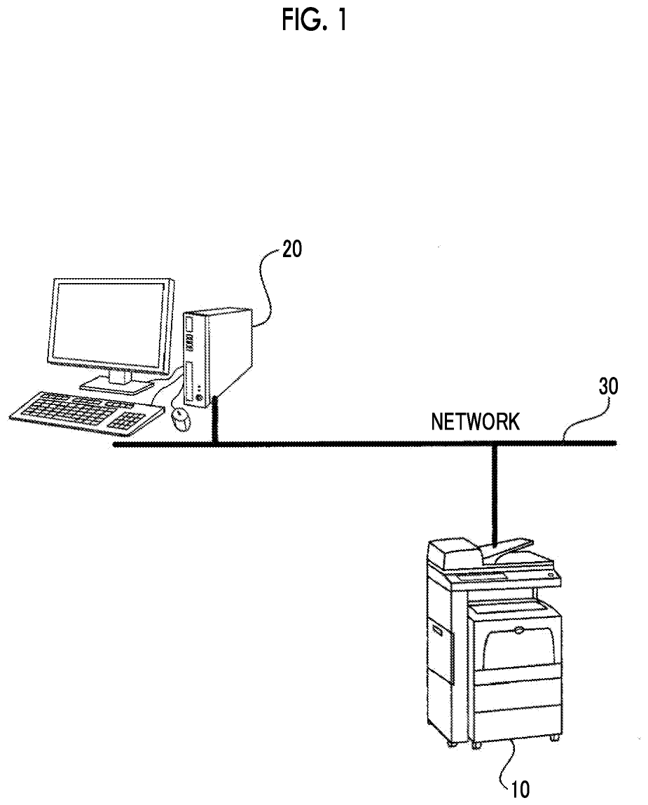

FIG. 1 is a diagram illustrating a configuration of an image forming system of the exemplary embodiment of the present invention.

Next, the exemplary embodiment of the present invention will be described in detail with reference to the drawings.

FIG. 1 is a diagram illustrating a system configuration of the image forming system of the exemplary embodiment of the present invention.

As illustrated in FIG. 1, the image forming system of the exemplary embodiment of the present invention is configured with an image forming apparatus 10 and a terminal apparatus 20 connected to each other via a network 30. The terminal apparatus 20 generates printing data and transmits the generated printing data to the image forming apparatus 10 via the network 30. The image forming apparatus 10 receives the printing data transmitted from the terminal apparatus 20 and outputs an image corresponding to the printing data on a paper sheet. The image forming apparatus 10 is an apparatus referred to as a so-called multifunction peripheral having a plurality of functions such as a printing function, a scanning function, a copying function, and a facsimile function.

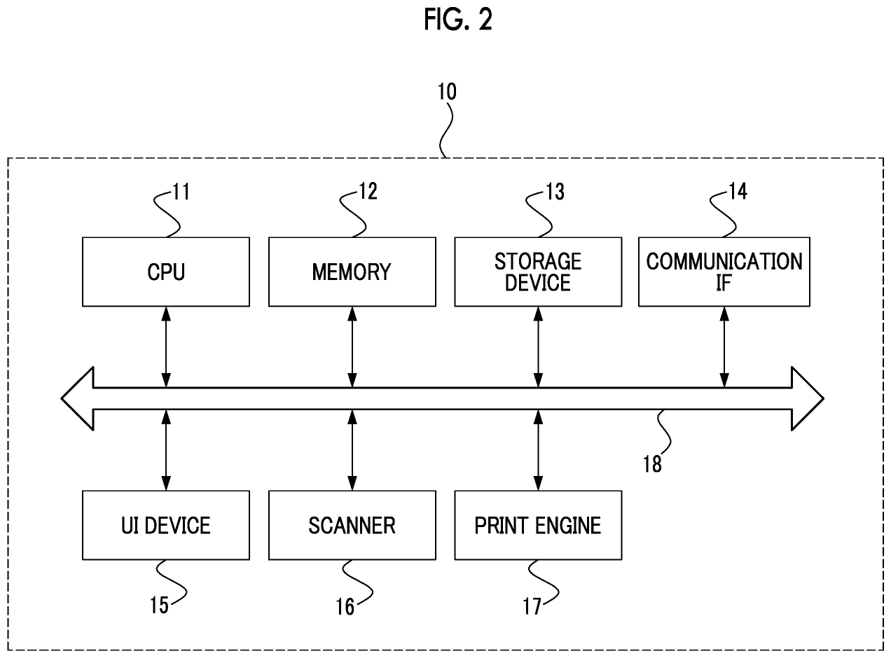

Next, a hardware configuration of the image forming apparatus 10 in the image forming system of the present exemplary embodiment is illustrated in FIG. 2.

As illustrated in FIG. 2, the image forming apparatus 10 includes a CPU 11, a memory 12, a storage device 13 such as a hard disk drive, a communication interface (abbreviated to IF) 14 that transmits and receives data to and from an external apparatus or the like via the network 30, a user interface (abbreviated to UI) device 15 that includes a touch panel or a liquid crystal display and a keyboard, a scanner 16, and a print engine 17. These constituents are connected to each other via a control bus 18.

The print engine 17 prints an image on a recording medium such as a printing paper sheet through steps of electrostatic charging, exposure, development, transfer, fixing, and the like.

The CPU 11 is a processor that controls an operation of the image forming apparatus 10 by executing a predetermined process based on a control program stored in the memory 12 or the storage device 13. In the present exemplary embodiment, while the CPU 11 is described as reading and executing the control program stored in the memory 12 or the storage device 13, the present invention is not limited thereto. The control program may be provided in the form of a recording on a computer readable recording medium. For example, this program may be provided in the form of a recording on an optical disc such as a compact disc (CD)-ROM and a digital versatile disc (DVD)-ROM or in the form of a recording on a semiconductor memory such as a universal serial bus (USB) memory and a memory card. In addition, the control program may be acquired from an external apparatus via a communication line connected to the communication interface 14.

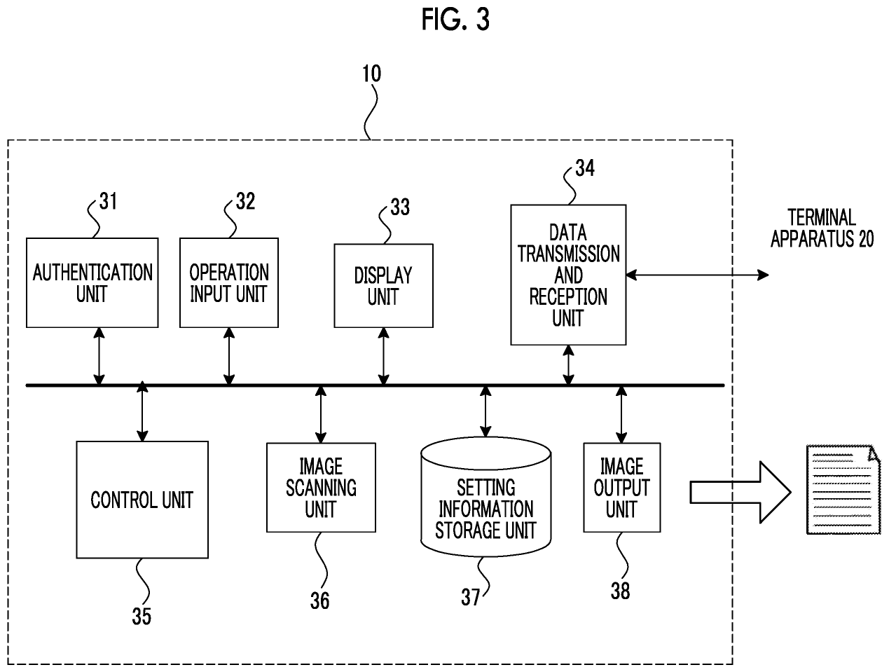

FIG. 3 is a block diagram illustrating a functional configuration of the image forming apparatus 10 implemented by executing the control program.

As illustrated in FIG. 3, the image forming apparatus 10 of the present exemplary embodiment includes an authentication unit 31, an operation input unit 32, a display unit 33, a data transmission and reception unit 34, a control unit 35, an image scanning unit 36, a setting information storage unit 37, and an image output unit 38.

The authentication unit 31 executes an authentication process for a user who wants to use the image forming apparatus 10. The display unit 33 is controlled by the control unit 35 and displays various information to the user. The operation input unit 32 inputs information about various operations performed by the user.

The data transmission and reception unit 34 transmits and receives data to and from the external apparatus such as the terminal apparatus 20.

The control unit 35 controls an overall operation of the image forming apparatus 10 and performs a control of generating the printing data based on a printing job received from the terminal apparatus 20 via the data transmission and reception unit 34 and outputting the generated printing data from the image output unit 38, a control of scanning an original document image by the image scanning unit 36, and the like. The setting information storage unit 37 stores job history information indicating an execution history of various jobs such as the printing job, a scanning job, a copying job, and a fax transmission job executed by the control unit 35 and setting information in which a setting value in executing a process is stored for each setting item. Here, the job history information is history information of a processing content of a job executed in the past.

The image output unit 38 outputs the image onto the recording medium such as a printing paper sheet under control of the control unit 35. The image scanning unit 36 scans the original document image from a set original document under control of the control unit 35.

Here, the setting information storage unit 37 stores a personal setting information management table for managing personal setting information that is the setting information in which the setting value in executing the process is stored for each setting item and that is usable by only a specific user, and a shared setting information management table for managing shared setting information usable by a plurality of users.

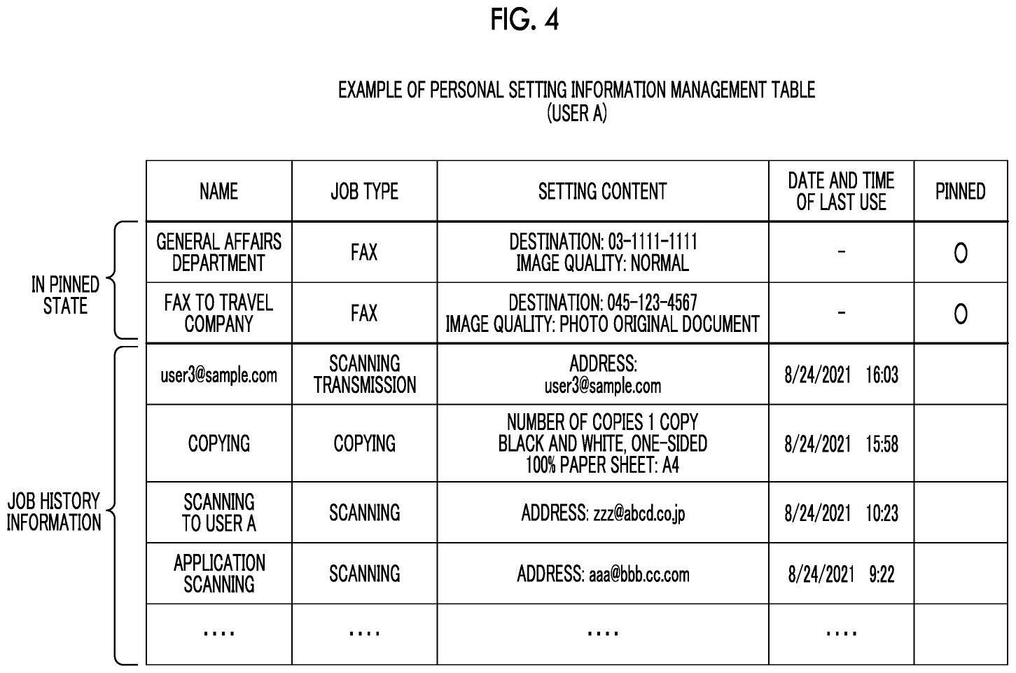

An example of the personal setting information management table stored in the setting information storage unit 37 is illustrated in FIG. 4.

With reference to FIG. 4, the job history information consisting of a name, a job type, a setting content, and a date and time of last use of each job executed in the past and the personal setting information pinned by an operation of the user in the job history information are managed in the personal setting information management table. In a case where the user wants to execute a job having the same content as the setting content in the job executed in the past, the user can execute the job with the same setting content as the setting content such as the setting values in the job history information by selecting the job history information. Even the job history information is included in the personal setting information usable by only a specific user. That is, the job history information is personal setting information in a non-pinned state. In the following description, the setting information in the pinned state usable by only a specific user will be referred to as the personal setting information, and the setting information in the non-pinned state usable by only a specific user will be referred to as the job history information.

In a case where the job is executed by the user using the image forming apparatus 10, new job history information is generated each time the job is executed. However, a data storage region is limited, and the data storage region may be insufficient for storing all job history information. Thus, for example, an upper limit for leaving the job history information of only the most recent 200 jobs is set, and the job history information exceeding the upper limit is deleted in order of date and time of execution from the oldest.

Therefore, a job history not to be deleted can be set to be pinned so that the job history not to be deleted is not set as a deletion target. The job history set to be pinned is managed as the personal setting information and is left without being deleted even in a case where the number of jobs subsequently executed exceeds the upper limit.

For example, with reference to the personal setting information management table in FIG. 4, setting information of names “general affairs department” and “fax to travel company” that is pinned to be managed separately from normal job history information is perceived. That is, this pinned personal setting information is left regardless of the number of subsequently executed jobs and remains displayed on an operation screen. Thus, in a case where frequently used job history information is registered as the personal setting information by performing a pin operation on the frequently used job history information, the job can be executed with the same setting content using the personal setting information any number of times.

Here, for example, the personal setting information and the job history information illustrated in FIG. 4 are setting information usable by only a specific user such as a user A. However, a plurality of users may want to use such setting information. Thus, the personal setting information can be changed to shared setting information. The shared setting information is usable by all logged-in users.

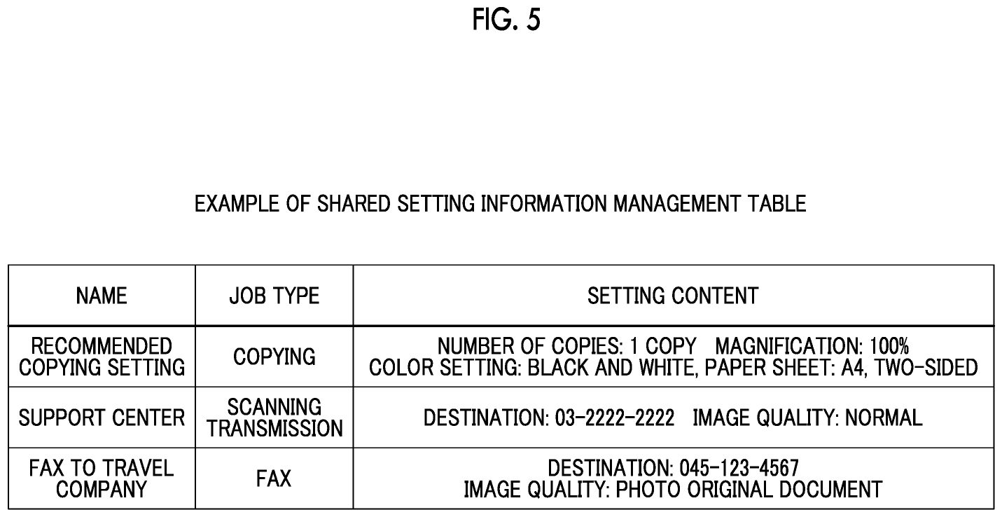

An example of the shared setting information management table for managing the shared setting information is illustrated in FIG. 5.

With reference to FIG. 5, information such as the name, the job type, and the setting content of each job is managed in the shared setting information management table.

For example, with reference to the shared setting information management table in FIG. 5, shared setting information of a name “recommended copying setting” has a job type “copying”, and the setting content of the shared setting information is stored. For example, in the shared setting information “recommended copying setting”, a setting value “one copy” is set for a setting item “number of copies”, and a setting value “100%” is set for a setting item “magnification”.

However, in a case where a general user who uses the apparatus is allowed to freely register the personal setting information as the shared setting information, the shared setting information having the same setting content may be registered by each user, and unnecessary shared setting information may be added. In addition, a large amount of shared setting information may be registered. Thus, perceiving which shared setting information is to be selected may be difficult, and using the image forming apparatus 10 may be difficult.

Thus, in displaying a setting screen including the personal setting information and the shared setting information on the display unit 33, the control unit 35 receives an operation of registering the personal setting information as the shared setting information from only a manager user who has broader authorization than the general user who uses the image forming apparatus 10.

Here, the general user is a user who is permitted to use the apparatus and is not permitted to change core setting of the apparatus. In addition, the manager user is a user who is referred to a machine manager and is granted broader authorization than the general user by requiring authentication such as input of a special password. The manager user is a user responsible for managing the apparatus.

However, the general user can also register new shared setting information instead of the manager user. In this case, the general user who has registered the new shared setting information is a user having special authorization for the shared setting information and can correct the setting content of the shared setting information and change an attribute.

In the image forming apparatus 10 of the present exemplary embodiment, a function of executing a new job using the setting content in the job executed in the past by selecting the job history information, the personal setting information, and the shared setting information is provided as a quick function.

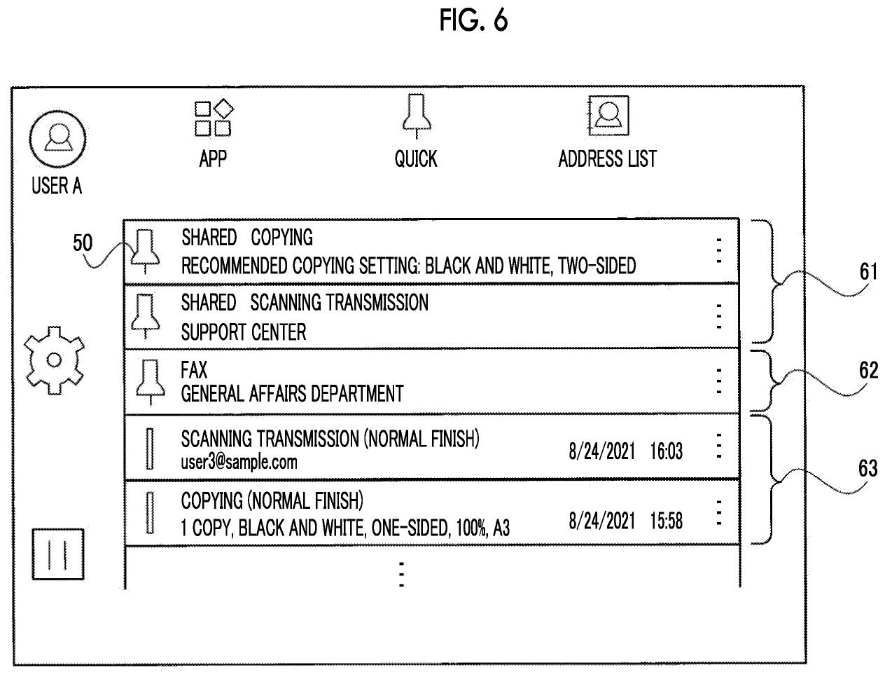

A display screen example displayed in a case where the user performs a touch operation on an icon for using the quick function is illustrated in FIG. 6.

The control unit 35 generates a display screen as illustrated in FIG. 6 based on the personal setting information management table and the shared setting information management table stored in the setting information storage unit 37 and displays the display screen on an operation panel. In the display screen example illustrated in FIG. 6, display of a list of shared setting information 61, personal setting information 62, and job history information 63 is perceived.

The display screen example of the quick function illustrated in FIG. 6 is a display screen example displayed in a case where the user A logs in in a state where the personal setting information management table illustrated in FIG. 4 and the shared setting information management table illustrated in FIG. 5 are stored in the setting information storage unit 37. Display of a part of the job history displayed on the display screen of the list of the job history is omitted because of a display space.

In the display screen example illustrated in FIG. 6, the shared setting information 61 and the personal setting information 62 are displayed by attaching a pin mark 50 indicating the pinned state to the shared setting information 61 and the personal setting information 62.

As new jobs are executed, the job history information 63 is sequentially deleted in order from the oldest. However, the shared setting information 61 and the personal setting information 62 to which the pin mark 50 is attached are not affected even in a case where new jobs are executed, and remain displayed in the same location without a change in display position.

In a case where the user wants to execute the job having the same content as the job executed in the past, the user can execute the job with an intended setting content without performing detailed setting, by simply selecting the same or similar setting content to the setting content of the job to be executed from the displayed list of the shared setting information 61, the personal setting information 62, and the job history information 63.

For example, the user can execute scanning transmission to the same destination in the same manner as usual without inputting destination information and various setting values, by simply selecting the shared setting information having a name “support center”.

Next, an operation in a case where the user performs an operation on the display screen will be described.

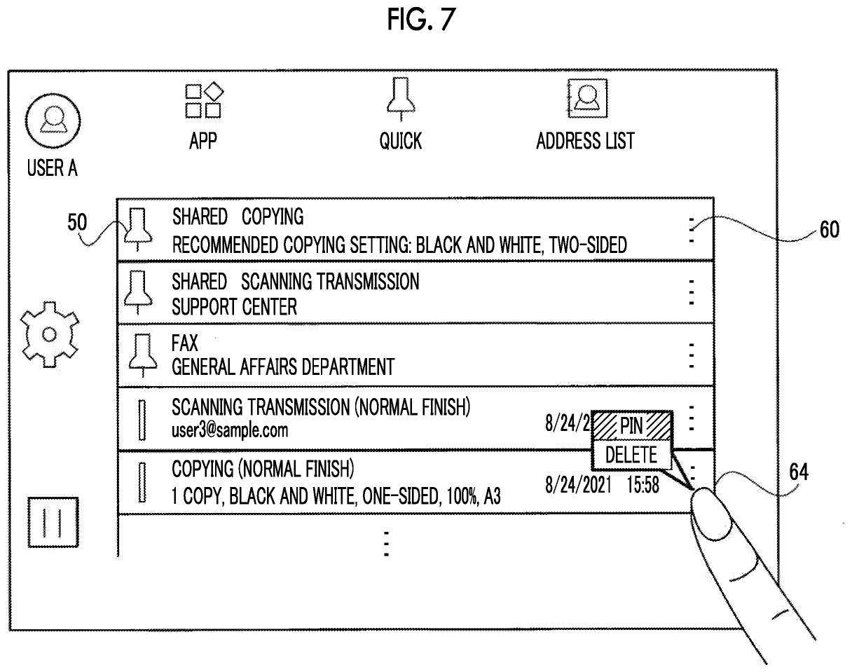

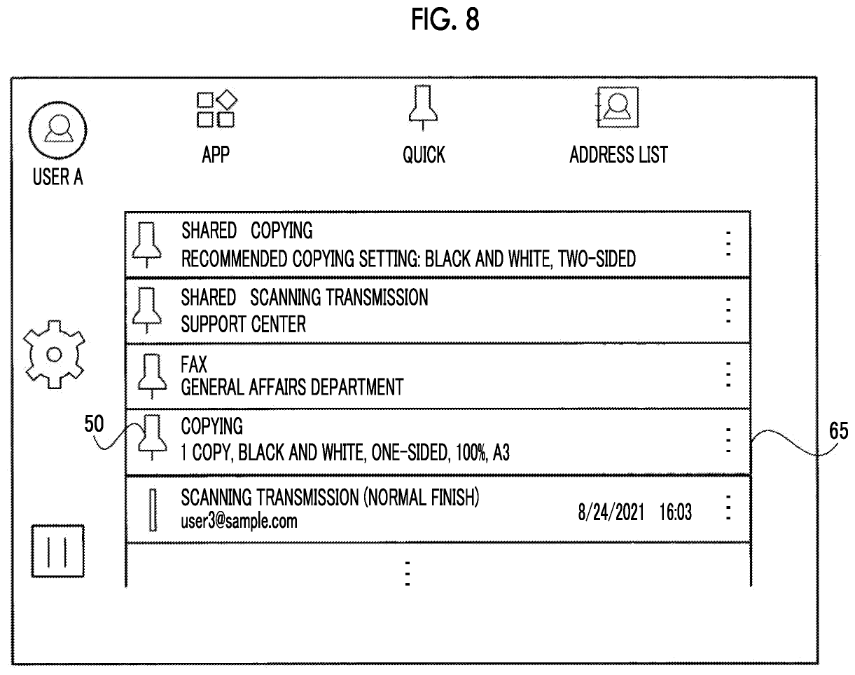

First, an operation example in a case where the general user registers the job history information as the personal setting information by pinning the job history information is illustrated in FIG. 7 and FIG. 8.

On the operation screen illustrated in FIG. 7, an operation menu button 60 is displayed at a right end of all of the shared setting information, the personal setting information, and the job history information so that various operations can be executed.

For example, in FIG. 7, an operation menu displayed in a case where the user A who is the general user operates the operation menu button 60 displayed in job history information 64 is illustrated.

On the operation screen in FIG. 7, display of an operation menu consisting of operation items “pin” and “delete” is perceived. In a case where the user selects the operation item “pin” from the operation menu, the job history information 64 is pinned to be changed to the personal setting information.

An operation screen example after the job history information 64 is pinned to be changed to personal setting information 65 is illustrated in FIG. 8.

With reference to FIG. 8, creation of the new personal setting information 65 to which the pin mark 50 is attached by pinning the job history information 64 in FIG. 7 is perceived.

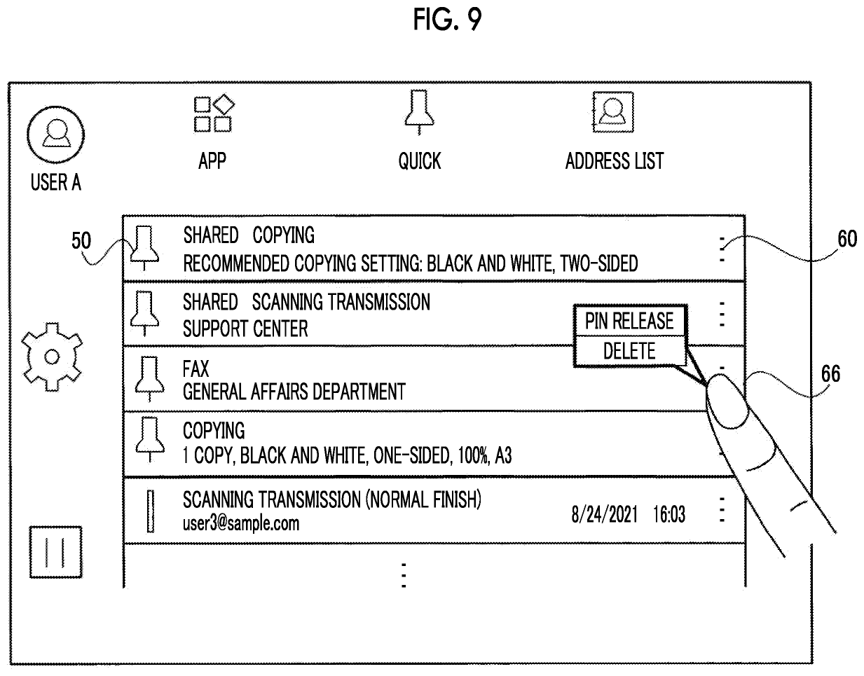

In addition, an operation menu example in a case where the user A operates the operation menu button 60 of personal setting information 66 in the pinned state is illustrated in FIG. 9.

As illustrated in FIG. 9, in a case where the user A operates the operation menu button 60 of the personal setting information that is already in the pinned state, operation items “pin release” and “delete” are displayed in the operation menu. In a case where the user A selects the operation item “pin release” from the operation menu, the personal setting information 66 is released from the pinned state and returns to normal job history information. In addition, in a case where the user A selects the operation item “delete” from the operation menu, the personal setting information 66 is deleted.

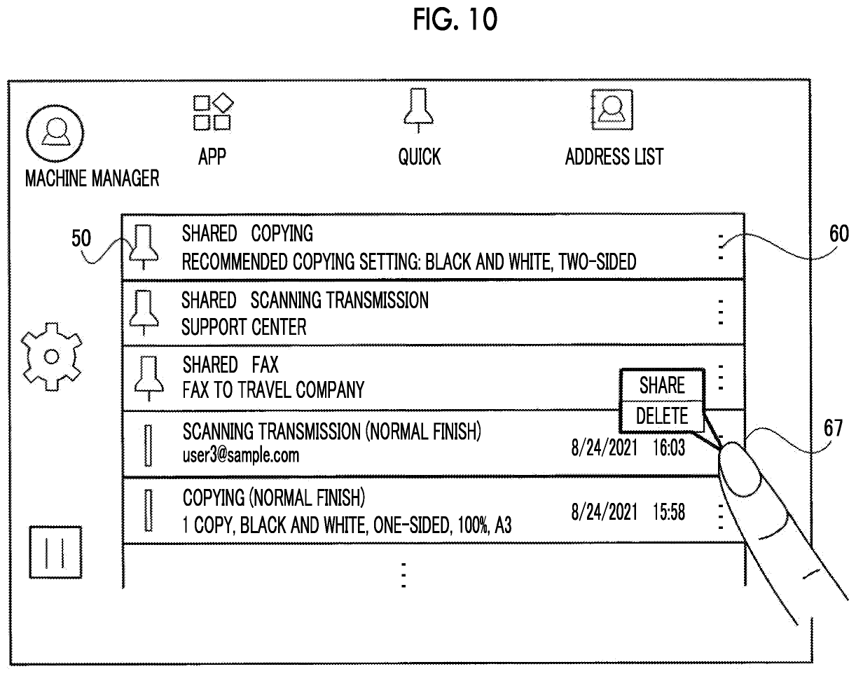

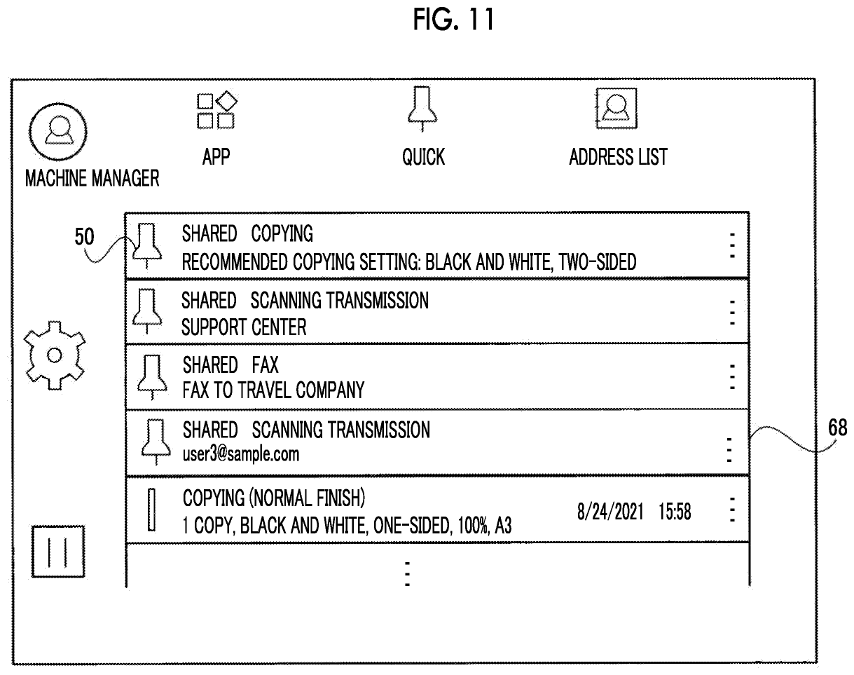

Next, an operation example in a case where the manager user logs in to the image forming apparatus 10 and registers new shared setting information is illustrated in FIG. 10 and FIG. 11.

As illustrated in FIG. 10, in a case where the manager user who is the machine manager operates the operation menu button 60 of the job history information of a name “user3@sample.com” in a state where the manager user has logged in to the image forming apparatus 10, operation items “share” and “delete” are displayed in the operation menu. In a case where the manager user selects the operation item “share” from the operation menu, job history information 67 is registered as the shared setting information.

An operation screen example after the job history information 67 is changed to shared setting information 68 is illustrated in FIG. 11.

With reference to FIG. 11, creation of the new shared setting information 68 to which the pin mark 50 is attached by performing an operation of sharing the job history information 67 in FIG. 10 is perceived.

As described above, the manager user can newly register the shared setting information. The newly registered shared setting information is displayed on the display screen of the quick function of all users. Thus, all users can execute the job with the same setting content.

In a case of providing the shared setting information to the plurality of users, execution of the process in a state where a setting value of a specific setting item is changed may be to be prohibited.

For example, an assumption that in creating shared setting information for printing a document based on document data stored on a company intranet, special setting such as printing a special pattern in a background, embedding a digital watermark, or printing an annotation such as “copying prohibited” is obliged in order to prevent leakage of a content of the document is made. In such a case, in a case where a user who can change the setting content of the shared setting information is limited to the manager user, and an attribute for prohibiting a change of the setting value is assigned to the specific setting item included in the shared setting information, the general user cannot execute the job with only a preset setting content for the setting item for which the change of the setting value is prohibited. That is, using this shared setting information can ensure that the job is executed under a special setting condition at all times.

However, even in a case where the attribute for prohibiting the change of the setting value is assigned to the specific setting item included in the shared setting information, the process can be executed in a state where the setting value of the specific setting item is changed, in a case where the process is executed using the shared setting information or in a case where the shared setting information is duplicated as personal setting information. That is, in a case where a user executes a certain job using the shared setting information, the job history information of the job is generated as the personal setting information. Thus, in a case where the user can change the setting content, the job can be executed after changing the setting value of the specific setting item of which the setting content is not to be changed.

Therefore, in the image forming apparatus 10 of the present exemplary embodiment, a method described below prevents the execution of the process in a state where the setting value of the setting item is changed in a case where the attribute for prohibiting the change of the setting value is assigned to the specific setting item of the shared setting information usable by the plurality of users.

First, in a case where the process such as various jobs is executed, the control unit 35 generates the setting information in which the setting value in executing the process is stored for each setting item. Specifically, in a case where a user executes the process such as various jobs, the control unit 35 generates the setting information in which the setting value in executing the job is stored for each setting item as the job history information. The job history information is pinned by each user to be changed to the personal setting information, and the manager user performs an operation of changing the job history information or the personal setting information to the shared setting information. Accordingly, new shared setting information is generated and registered.

The control unit 35 displays the setting screen including the personal setting information usable by only the specific user and the shared setting information usable by the plurality of users on the operation panel.

Here, in a case where the personal setting information is changed to the shared setting information, and a designation of the setting item for which the change of the setting value is prohibited among the setting items included in the setting information is received, the control unit 35 assigns the attribute for prohibiting the change of the setting value to the setting item for which the designation for prohibiting the change of the setting value is received.

In a case where the process is executed using the setting information including the setting item to which the attribute for prohibiting the change of the setting value is assigned, the control unit 35 assigns the attribute for prohibiting the change of the setting value to a setting item corresponding to the setting item to which the attribute for prohibiting the change of the setting value is assigned among setting items of setting information generated in a case where the process is executed.

In addition, for any of the shared setting information, the personal setting information, and the job history information, the control unit 35 does not receive an operation of changing the setting value of the setting item to which the attribute for prohibiting the change of the setting value is assigned, on a screen on which the setting content of the setting information is displayed.

Specifically, the control unit 35 displays an operator for changing the setting value of the setting item to which the attribute for prohibiting the change of the setting value is assigned, in an inoperable state on the screen on which the setting content of the setting information is displayed.

Alternatively, the control unit 35 may not display the operator for changing the setting value of the setting item to which the attribute for prohibiting the change of the setting value is assigned, on the screen on which the setting content of the setting information is displayed.

In the image forming apparatus 10 of the present exemplary embodiment, the shared setting information can be duplicated as the personal setting information by an operation of the general user. Thus, in duplicating the shared setting information as the personal setting information, in a case where the setting item to which the attribute for prohibiting the change of the setting value is assigned is included in the shared setting information, the control unit 35 duplicates the shared setting information together with the attribute for prohibiting the change of the setting value.

The control unit 35 may not manage the attribute for prohibiting the change of the setting value for each setting item. In a case where the personal setting information is changed to the shared setting information, and the designation for prohibiting the change of the setting value is received, the control unit 35 may collectively assign the attribute for prohibiting the change of the setting value to all setting items included in the setting information.

However, prohibiting any change to setting information in which the attribute for prohibiting the change of the setting is assigned to a certain setting item may cause inconvenience. Thus, the control unit 35 may change the attribute for prohibiting the change of the setting value of the setting item included in the shared setting information by an operation of a user having preset authorization.

Specifically, for example, the control unit 35 may change the attribute for prohibiting the change of the setting value of the setting item included in the shared setting information by an operation of the manager user who has executed a preset authentication process.

In addition, authorization to change the shared setting information can also be granted to a specific general user other than the manager user. In this case, the general user to which the authorization to change the shared setting information is granted is the user having the preset authorization.

Furthermore, as described above, in a case of enabling the general user to register the shared setting information, the general user is the user having the preset authorization with respect to the shared setting information registered by the general user.

Thus, the control unit 35 may change the attribute for prohibiting the change of the setting value of the setting item included in the shared setting information by an operation of the general user who has registered the shared setting information.

In addition, changing the attribute for prohibiting the change of the setting value includes not only deleting the attribute for prohibiting the change of the setting but also a process of newly assigning the attribute for prohibiting the change of the setting.

That is, the control unit 35 may delete the attribute for prohibiting the change of the setting value assigned to the setting item included the shared setting information by the operation of the user having the preset authorization.

In addition, the control unit 35 may assign the attribute for prohibiting the change of the setting value to the setting item included the shared setting information by the operation of the user having the preset authorization.

By doing so, for example, in a case where the manager user checks the shared setting information registered by the general user, the attribute for prohibiting the change of the setting value can be assigned to the setting item for which not prohibiting the change of the setting value is considered dangerous, by the authorization of the manager user.

Next, an operation of the image forming apparatus 10 of the present exemplary embodiment will be described in detail with reference to the drawings.

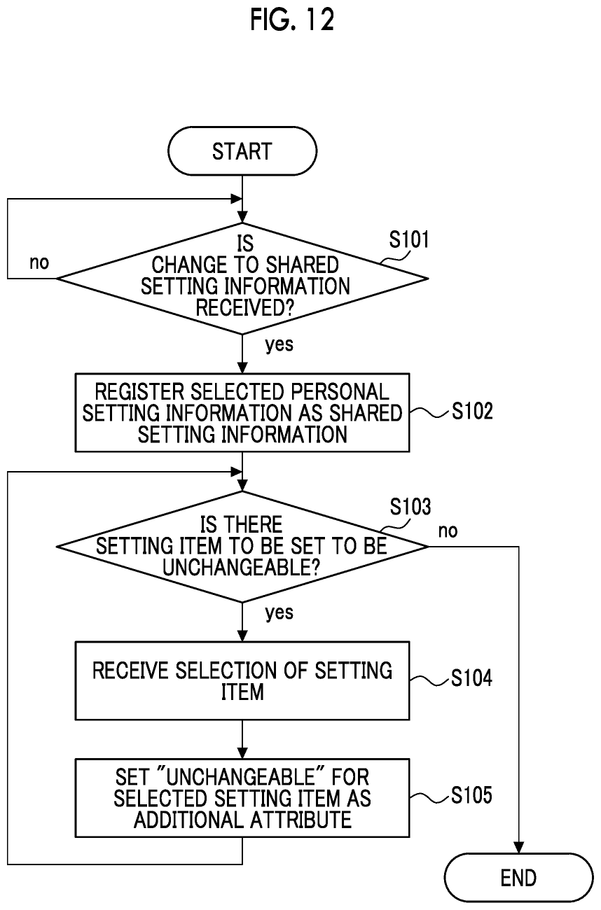

First, an operation in a case where an operation in assigning the attribute for prohibiting the change of the setting value to a part of the setting items is performed by the manager user in changing the personal setting information such as the job history information to the shared setting information is illustrated in the flowchart in FIG. 12.

In step S101, the control unit 35 waits until the operation of changing the personal setting information to the shared setting information is received. In a case where the operation of changing the personal setting information to the shared setting information is received, the control unit 35 registers the selected personal setting information in the shared setting information management table illustrated in FIG. 5 as the shared setting information in step S102.

In step S103, the control unit 35 checks with the manager user whether or not there is a setting item of which the setting value is to be set to be unchangeable.

In step S103, in a case where a notification that there is no setting item of which the setting value is to be set to be unchangeable is received from the manager user, the control unit 35 finishes the process.

In step S103, in a case where a notification that there is a setting item of which the setting value is to be set to be unchangeable is received from the manager user, the control unit 35 receives a selection of the setting item of which the setting value is to be set to be unchangeable in step S104.

Next, in step S105, the control unit 35 sets an attribute “unchangeable” for the selected setting item as an additional attribute. That is, the control unit 35 assigns the attribute for prohibiting the change of the setting value to the selected setting item.

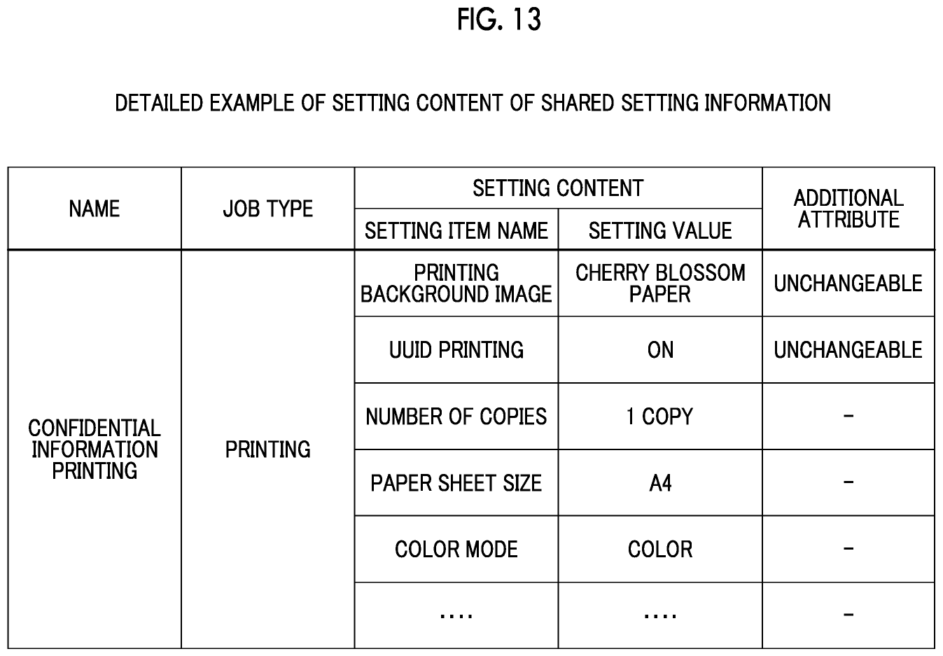

An example of the shared setting information to which the attribute for prohibiting the change of the setting value is assigned with respect to the part of the setting items is illustrated in FIG. 13.

In the example of the shared setting information illustrated in FIG. 13, assignment of the attribute “unchangeable” that is the attribute for prohibiting the change of the setting value to a setting item “printing background image” and a setting item “Universally Unique IDentifier (UUID) printing” is perceived. Here, UUID printing means a function of printing different identifiers for each document to be printed.

That is, in the shared setting information illustrated in FIG. 13, setting of printing a background image “cherry blossom paper” as the “printing background image” and setting of turning UUID printing “ON” are unchangeable.

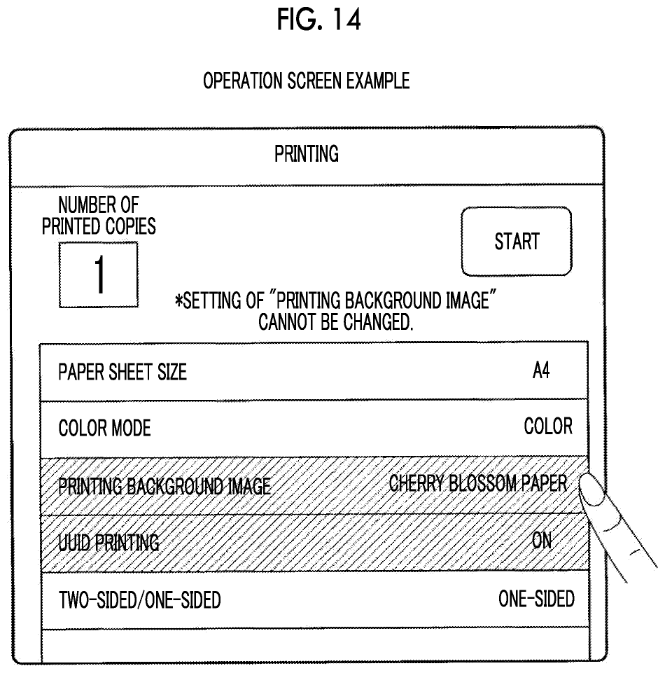

An operation screen example in a case where the general user attempts to execute a printing job using the shared setting information illustrated in FIG. 13 is illustrated in FIG. 14.

With reference to FIG. 14, the setting items “printing background image” and “UUID printing” are displayed in a grayed-out manner, and the operator for changing the setting value of the setting item to which the attribute “unchangeable” is assigned is displayed in an inoperable state. The operator for changing the setting value of the setting item to which the attribute “unchangeable” is assigned may not be displayed by not displaying the setting items “printing background image” and “UUID printing” that are setting items to which the attribute “unchangeable” is assigned.

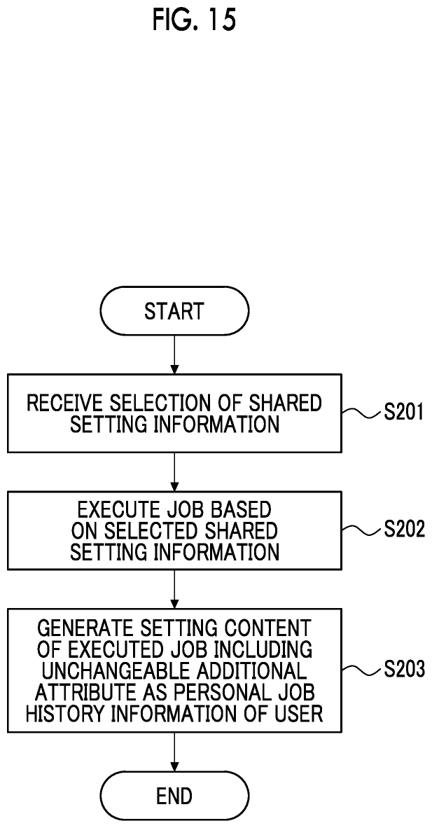

An operation of the image forming apparatus 10 in a case where a job is executed using the shared setting information including the setting item to which the attribute “unchangeable” is assigned is illustrated in the flowchart in FIG. 15.

First, in step S201, the control unit 35 receives a selection of the shared setting information by an operation of the user. In step S202, the control unit 35 executes the job based on the selected shared setting information.

In step S203, the control unit 35 generates the executed setting content together with the unchangeable additional attribute as the personal job history information of the user.

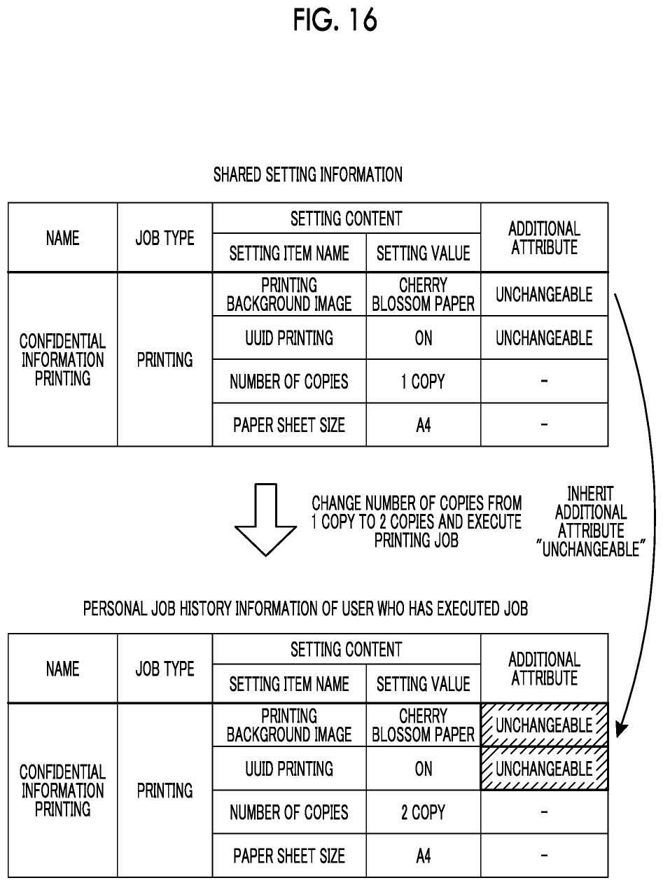

An example of the generated job history information is illustrated in FIG. 16. In FIG. 16, a case where the general user executes the job by selecting the shared setting information illustrated in FIG. 13 and changing a setting item “number of copies” from “1 copy” to “2 copies” is illustrated.

With reference to FIG. 16, a state where in a case where the job is executed using the setting information including the setting item to which the attribute “unchangeable” is assigned, the attribute “unchangeable” remains assigned even in the generated job history information is perceived.

Thus, even in a case where the user executes the job by selecting the generated job history information, the setting values of the setting items “printing background image” and “UUID printing” cannot be changed.

Thus, the general user is prevented from executing the job by changing the setting values of the setting items “printing background image” and “UUID printing”.

Even in the job history information generated in a case where the user executes the job again by selecting the job history information illustrated in FIG. 16, the job history information is generated in a state where the setting item to which the attribute “unchangeable” is assigned remains, that is, in a state where the attribute “unchangeable” is assigned.

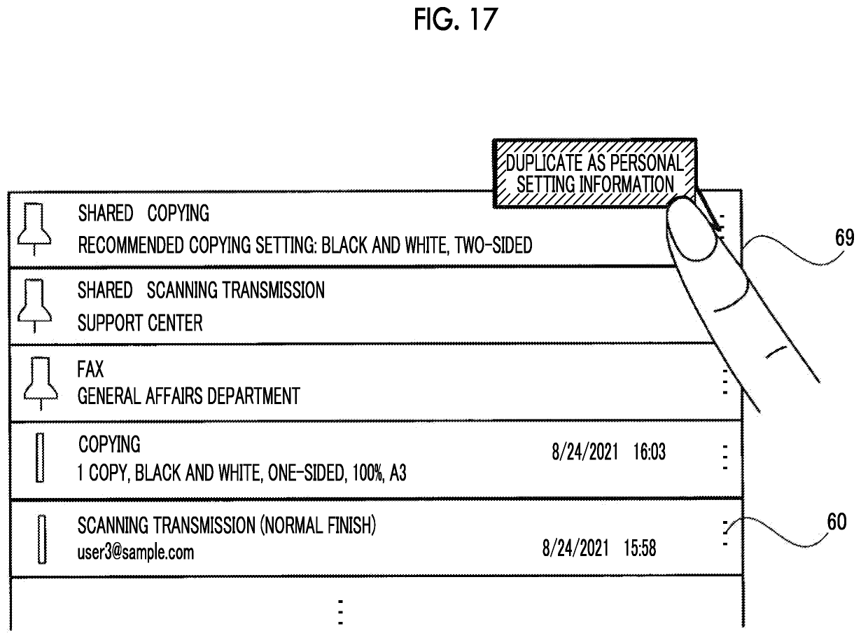

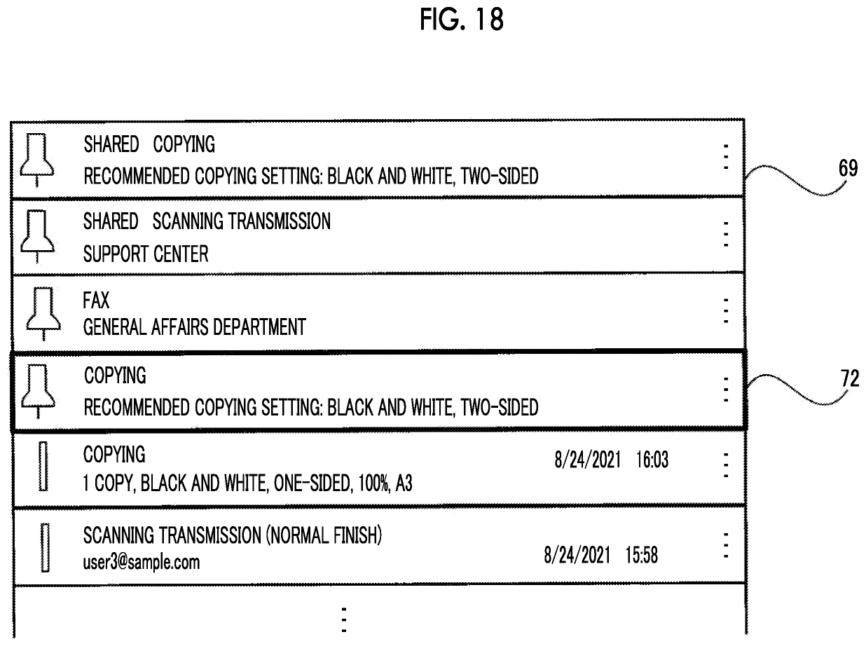

Last, an operation in a case where the general user changes the shared setting information to the personal setting information of the general user will be described with reference to FIG. 17 and FIG. 18.

For example, in a case where a general user uses shared setting information 69 of the name “recommended copying setting” under management of the general user, the general user operates the operation menu button 60 of the shared setting information 69 as illustrated in FIG. 17. Then, in the display screen example in FIG. 17, an assumption that a setting item “duplicate as personal setting information” is displayed and the general user selects the setting item is made.

Then, as illustrated in FIG. 18, personal setting information 72 having the same setting content as the shared setting information 69 is newly created and added on a list display screen in a state where the shared setting information 69 is left.

In newly creating the personal setting information 72 by duplicating the shared setting information 69, the control unit 35 duplicates the shared setting information 69 together with the attribute for prohibiting the change of the setting value in a case where the setting item to which the attribute for prohibiting the change of the setting value is assigned is included in the shared setting information.

As described above, in the image forming apparatus 10 of the present exemplary embodiment, in a case where the attribute “unchangeable” is assigned to at least a part of the setting items of the shared setting information, a state where the attribute “unchangeable” is assigned is inherited in any of the job history information of the job executed based on the shared setting information, the job history information of the job executed by selecting the job history information, and the personal setting information generated by duplicating the shared setting information.

Thus, for the setting item to which the attribute “unchangeable” is assigned by the manager user in generating the shared setting information, the execution of the job in a state where the setting value of the setting item is changed is prevented.

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### MODIFICATION EXAMPLE

While the exemplary embodiment is described using a case where the present invention is applied to an image forming apparatus forming an image on a recording medium, the present invention is not limited thereto. The present invention can also be applied to an information processing apparatus such as a personal computer or a portable terminal apparatus that stores setting information in which a setting value is stored for each setting item, and that executes a process using the stored setting information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
in a case where a process is executed, generate setting information in which a setting value in executing the process is stored for each setting item;
display a setting screen including personal setting information usable by only a specific user and shared setting information usable by a plurality of users;
in a case where the personal setting information is changed to the shared setting information, and a designation of a setting item for which a change of the setting value is prohibited among setting items included in the setting information is received, assign an attribute for prohibiting the change of the setting value to the setting item for which the designation for prohibiting the change of the setting value is received; and
in a case where the process is executed using the setting information including the setting item to which the attribute for prohibiting the change of the setting value is assigned, assign the attribute for prohibiting the change of the setting value to a setting item corresponding to the setting item to which the attribute for prohibiting the change of the setting value is assigned among setting items of setting information generated in a case where the process is executed.

2. The information processing apparatus according to claim 1, wherein the processor is configured to:
not receive an operation of changing the setting value of the setting item to which the attribute for prohibiting the change of the setting value is assigned, on a screen on which a setting content of the setting information is displayed.

3. The information processing apparatus according to claim 2, wherein the processor is configured to:
display an operator for changing the setting value of the setting item to which the attribute for prohibiting the change of the setting value is assigned, in an inoperable state on the screen on which the setting content of the setting information is displayed.

4. The information processing apparatus according to claim 2, wherein the processor is configured to:
not display an operator for changing the setting value of the setting item to which the attribute for prohibiting the change of the setting value is assigned, on the screen on which the setting content of the setting information is displayed.

5. The information processing apparatus according to claim 1, wherein the processor is configured to:
in duplicating the shared setting information as the personal setting information, in a case where the setting item to which the attribute for prohibiting the change of the setting value is assigned is included in the shared setting information, duplicate the shared setting information together with the attribute for prohibiting the change of the setting value.

6. The information processing apparatus according to claim 2, wherein the processor is configured to:
in duplicating the shared setting information as the personal setting information, in a case where the setting item to which the attribute for prohibiting the change of the setting value is assigned is included in the shared setting information, duplicate the shared setting information together with the attribute for prohibiting the change of the setting value.

7. The information processing apparatus according to claim 3, wherein the processor is configured to:
in duplicating the shared setting information as the personal setting information, in a case where the setting item to which the attribute for prohibiting the change of the setting value is assigned is included in the shared setting information, duplicate the shared setting information together with the attribute for prohibiting the change of the setting value.

8. The information processing apparatus according to claim 4, wherein the processor is configured to:
in duplicating the shared setting information as the personal setting information, in a case where the setting item to which the attribute for prohibiting the change of the setting value is assigned is included in the shared setting information, duplicate the shared setting information together with the attribute for prohibiting the change of the setting value.

9. The information processing apparatus according to claim 1, wherein the processor is configured to:
in a case where the personal setting information is changed to the shared setting information, and the designation for prohibiting the change of the setting value is received, assign the attribute for prohibiting the change of the setting value to all setting items included in the setting information.

10. The information processing apparatus according to claim 2, wherein the processor is configured to:
in a case where the personal setting information is changed to the shared setting information, and the designation for prohibiting the change of the setting value is received, assign the attribute for prohibiting the change of the setting value to all setting items included in the setting information.

11. The information processing apparatus according to claim 3, wherein the processor is configured to:
in a case where the personal setting information is changed to the shared setting information, and the designation for prohibiting the change of the setting value is received, assign the attribute for prohibiting the change of the setting value to all setting items included in the setting information.

12. The information processing apparatus according to claim 4, wherein the processor is configured to:
in a case where the personal setting information is changed to the shared setting information, and the designation for prohibiting the change of the setting value is received, assign the attribute for prohibiting the change of the setting value to all setting items included in the setting information.

13. The information processing apparatus according to claim 5, wherein the processor is configured to:
in a case where the personal setting information is changed to the shared setting information, and the designation for prohibiting the change of the setting value is received, assign the attribute for prohibiting the change of the setting value to all setting items included in the setting information.

14. The information processing apparatus according to claim 1, wherein the processor is configured to:
change the attribute for prohibiting the change of the setting value of the setting item included in the shared setting information by an operation of a user having preset authorization.

15. The information processing apparatus according to claim 14, wherein the processor is configured to:
change the attribute for prohibiting the change of the setting value of the setting item included in the shared setting information by an operation of a manager user who has executed a preset authentication process.

16. The information processing apparatus according to claim 14, wherein the processor is configured to:
change the attribute for prohibiting the change of the setting value of the setting item included in the shared setting information by an operation of a user who has registered the shared setting information.

17. The information processing apparatus according to claim 14, wherein the processor is configured to:
delete the attribute for prohibiting the change of the setting value assigned to the setting item included in the shared setting information by the operation of the user having the preset authorization.

18. The information processing apparatus according to claim 14, wherein the processor is configured to:
assign the attribute for prohibiting the change of the setting value to the setting item included in the shared setting information by the operation of the user having the preset authorization.

19. A non-transitory computer readable medium storing a program causing a computer to execute a process comprising:
generating, in a case where a process is executed, setting information in which a setting value in executing the process is stored for each setting item;
displaying a setting screen including personal setting information that is the setting information in which the setting value in executing the process is stored for each setting item and that is usable by only a specific user, and shared setting information usable by a plurality of users;
assigning, in a case where the personal setting information is changed to the shared setting information, and a designation of a setting item for which a change of the setting value is prohibited among setting items included in the setting information is received, an attribute for prohibiting the change of the setting value to the setting item for which the designation for prohibiting the change of the setting value is received; and
assigning, in a case where the process is executed using the setting information including the setting item to which the attribute for prohibiting the change of the setting value is assigned, the attribute for prohibiting the change of the setting value to a setting item corresponding to the setting item to which the attribute for prohibiting the change of the setting value is assigned among setting items of setting information generated in a case where the process is executed.

20. An information processing method comprising:
generating, in a case where a process is executed, setting information in which a setting value in executing the process is stored for each setting item;
displaying a setting screen including personal setting information that is the setting information in which the setting value in executing the process is stored for each setting item and that is usable by only a specific user, and shared setting information usable by a plurality of users;
assigning, in a case where the personal setting information is changed to the shared setting information, and a designation of a setting item for which a change of the setting value is prohibited among setting items included in the setting information is received, an attribute for prohibiting the change of the setting value to the setting item for which the designation for prohibiting the change of the setting value is received; and
assigning, in a case where the process is executed using the setting information including the setting item to which the attribute for prohibiting the change of the setting value is assigned, the attribute for prohibiting the change of the setting value to a setting item corresponding to the setting item to which the attribute for prohibiting the change of the setting value is assigned among setting items of setting information generated in a case where the process is executed.
